(19) United States
(12) Patent Application Publication
(10) Pub. No.: US 2024/0158964 A1
(43) Pub. Date: May 16, 2024

(54) Tension Adjustment Method of Warp Knitting Variable-speed and Uniform-tension Yarn Feeding Device, and Weaving Method

(71) Applicant: Jiangnan University, Wuxi (CN)

(72) Inventors: Honglian Cong, Wuxi (CN); Gaoming Jiang, Wuxi (CN); Fenglin Xia, Wuxi (CN); Pibo Ma, Wuxi (CN); Luhong Li, Wuxi (CN)

(21) Appl. No.: 18/422,133

(22) Filed: Jan. 25, 2024

Related U.S. Application Data
(63) Continuation of application No. PCT/CN2023/101317, filed on Jun. 20, 2023.

(30) Foreign Application Priority Data
Jul. 18, 2022 (CN) 2022108441204

(51) Int. Cl. D04B 27/12; D04B 27/04; D04B 27/06; D04B 27/24; D04B 27/34

(52) U.S. Cl. CPC D04B 27/12; D04B 27/04; D04B 27/06; D04B 27/24; D04B 27/34

(57) ABSTRACT

Disclosed are a tension adjustment method of a warp knitting variable-speed and uniform-tension yarn feeding device, and a weaving method. The device includes warp beams, connecting rod frames, a guide bar, a looping mechanism and a drawing and rolling-up mechanism, where the connecting rod frames are connected to yarn winding wheels and yarn guide plates, yarns are wound on the warp beams, and the yarn winding wheels are positioned between the warp beams and the guide bar; each of the yarn winding wheels includes a yarn inlet, a yarn winding shaft and a yarn outlet. According to the present disclosure, the tension produced in a yarn feeding process is actively adjusted by the variable-speed tension yarn winding wheels to make up tension error caused by looping; and the present disclosure is capable of compensating in time, does not easily break the yarns, is high in knitting efficiency and quality.

### TECHNICAL FIELD

The present disclosure relates to a tension adjustment method of a warp knitting variable-speed and uniform-tension yarn feeding device, and a weaving method, belonging to the technical field of textile.

### BACKGROUND

Warp knitting is a textile process that belongs to the field of knitting. Knitted fabrics are formed by feeding one or several sets of parallel yarns into all working needles of a machine in the warp direction and looping same at the same time. This method is called warp knitting, and the formed knitted fabrics are called warp knitted fabrics. Warp knitting technology occupies an important position in the knitting industry, and its products are high in technology content and have great market potential.

Warp knitting machines are usually higher in machine speeds, and the warp yarns need to maintain a certain tension to form loops normally. If the tension is too low, the yarns cannot be straightened properly, and yarn guide needles cannot accurately complete lapping for knitting needles, causing the looping process to be interrupted. If the tension is too high, the yarns become too tight, making it difficult to unloop or breaking the yarns after looping, so that fabric quality and production efficiency are affected.

### SUMMARY

The objective of the present disclosure is to overcome the shortcomings of the prior art, and to provide a warp knitting variable-speed and uniform-tension yarn feeding device and a weaving method. The device achieves uniform tension in a yarn feeding process, ensures that yarns are not easily broken, improves machine weaving efficiency, keeps a fabric surface smooth, and enables fabrics to have high quality.

The first objective of the present disclosure is to provide a yarn feeding device, including warp beams, connecting rod frames, a guide bar, a looping mechanism and a drawing and rolling-up mechanism, where the connecting rod frames are connected to yarn winding wheels and yarn guide plates, yarns are wound on the warp beams, and the yarn winding wheels are positioned between the warp beams and the guide bar; each of the yarn winding wheels includes a yarn inlet, a yarn winding shaft and a yarn outlet, and a tension sensor is installed on the yarn winding shaft; yarn guide holes are reserved in the yarn guide plates; the warp beams rotate to send out the yarns, and the yarns are wound on the yarn winding shafts in a plurality of turns after being fed into the yarn inlets of the yarn winding wheels, and are led out from the yarn outlets for passing through the yarn guide holes in the yarn guide plates; and the yarn guide holes are configured to separate all the yarns so as to allow the yarns not to be not intertwined with each other.

In one implementation of the present disclosure, the yarn winding wheels can rotate, and the rotation speeds of the yarn winding wheels can be changed for adjustment of the tension on the yarns, and the yarn winding wheels are located above the yarn guide plates.

In one implementation of the present disclosure, yarn guide needles are distributed on the guide bar, and the yarns are fed into the looping mechanism by the yarn guide needles. The looping mechanism includes knitting needles, a needle bed, a sinker, a sinker bed, and a needle core bed, where the knitting needles are installed in the needle bed, the sinker is installed in the sinker bed, and a needle core is installed in the needle core bed; the guide bar moves transversely from left to right, so that the yarn guide needles transversely move back and forth between the knitting needles, complete a lapping looping movement by the knitting needles; and form greige cloth after loops disengage from the needles.

In one implementation of the present disclosure, the drawing and rolling-up mechanism includes a drawing roller and a cloth pressing roller; and the greige cloth produced by the looping mechanism is wound into the drawing roller and pulled flat, and then cloth bulges are pressed by the cloth pressing roller, so as to keep a cloth surface even.

In one implementation of the present disclosure, tension rods are provided between the yarn guide plates and the guide bar, and the yarns pass through the yarn guide holes in the yarn guide plates to be wound on the tension rods, and are then fed into the yarn guide needles at a lower end of guide bar.

In one implementation of the present disclosure, each of the yarn winding wheels further includes a dust cover and a central processing chip, where the dust cover is located at an outer side of the corresponding yarn winding shaft; the tension sensors are installed at lower ends of shaft walls of the yarn winding shafts, and the yarn winding shafts and the tension sensors are both in data connection with the central processing chips; the tension sensors are configured to detect tension fluctuations in a yarn feeding process and transmit the detected data to the central processing chips; and the central processing chips control the yarn winding shafts to rotate clockwise or counterclockwise according to the detected data so as to adjust the tension on the yarns in the yarn feeding process.

The second objective of the present disclosure is to provide a tension adjustment method of the yarn feeding device, which applies the yarn feeding device and includes the following steps:
when the tension on the yarns is uniform without abnormality, the yarns are wound into the yarn winding wheels in a certain number of turns in advance, the warp beams feed the yarns, and the yarn winding wheels synchronously lead out the yarns at a constant speed; the tension sensors are installed within an area 100 at the lower ends of the shaft walls of the yarn winding shafts; before knitting without yarn feeding, tension reset buttons 200 located at side ends of the connecting rod frames are pressed, and then the tension detection values of the tension sensors are calibrated to 0; when the tension on the yarns becomes uneven during machine weaving, the yarns wound on the yarn winding shafts will cause axial compression or relaxation on the shaft walls of the yarn winding shafts, so that the tension values measured by the tension sensors positioned within the bottom end area of the yarn winding shafts is increased to positive values or decreased to negative values;
when it is detected that the tension on the yarns is too high, the yarns produce axial pressure on the yarn winding shafts, the tension sensors detect the tension, and the measured value is positive; subsequently, the tension sensors release yarn release command to the central processing chips inside the yarn winding wheels, and the central processing chips process the command and output signals to the yarn winding wheels; the yarn winding wheels rotate counterclockwise to release the yarns to make up the tension gap, and the yarns wound on the yarn winding wheels in advance are thus led out; at the same time, the warp beams rotate synchronously to input the yarns into the yarn winding wheels; at this time, after the tension sensors detect that the tension on the yarns is normal, the output tension value is 0, and the yarn winding shafts resume the normal operation of uniform yarn winding;
when it is detected that the tension on the yarns is too low, the axial pressure of the yarns on the yarn winding shafts disappears or increases in a negative trend, the tension sensors detect the tension, and the measured value is negative; subsequently, the tension sensors release yarn winding command to the central processing chips inside the yarn winding wheels, and the central processing chips process the command and output signals to the yarn winding wheels; the yarn winding wheels rotate clockwise to release the yarns for relieving tension fluctuations, so that the number of winding turns of the yarns on the yarn winding shafts is increased; and at this time, after the tension sensors detect that the tension on the yarns is normal, the output tension value is 0, and the yarn winding shafts resume the normal operation of uniform yarn winding.

The third objective of the present disclosure is to provide a weaving method, which applies the yarn feeding device or the tension adjustment method of the yarn feeding device, and includes the following steps:
S1. a fabric is composed of a plurality of courses and wales, the fabric is woven from bottom to top; at the beginning of knitting the course A, the guide bar is located in the direction of backs of the needles, and thus needs to be corrected to the direction of fronts of the needles and moved to the right until moving to a right end of the selected knitting needle to complete overlapping; the knitting needle descends after being hooked into the yarns, the sinker moves radially, and the needle core also descends, accordingly; a needle mouth is blocked by the needle core, so that the yarns are completely locked inside the closed knitting needle, and an old loop slides upward from a needle bar along the needle core; the yarn guide needles swing towards the backs of the needles, and the knitting needle and the needle core descend together to a lowest position; a new loop falls off from the knitting needle and becomes another old loop, and the sinker holds the newly detached old loop and pulls same in the direction opposite to the needle bed;
S2. the weaving process of loops in each of the courses is similar to that in S1, except that the movement directions of the yarn guide needles and the stitch lengths across the backs of the needles; after the loop knitting of the course A is completed, the yarn guide needles are located at the backs of the knitting needles; at this time, the guide bar guides the yarn guide needles to move transversely to the left by two stitch lengths for weaving the course B;
S3. the loops in the course B are pulled by the yarn guide needles to allow the yarns to move transversely from the backs of the knitting needles that have completed the lapping looping movement in the course A to the left by two stitch lengths for arriving at a right end of the selected knitting needle; at this time, the guide bar guides the yarn guide needles to swing to a position in front of the needles, then to move to the left for completion of overlapping of the designated knitting needle; subsequently, the guide bar guides the yarn guide needles to move to the direction of the backs of the needles for completion of the lapping looping movement of the knitting needles in the course B;
S4. the loops in the course C are pulled by the yarn guide needles to move transversely from the backs of the knitting needles that have completed the lapping looping movement in the course B to the right by two stitch lengths for arriving at a left end of the knitting needle needing to complete the lapping looping movement, and then the guide bar guides the yarn guide needles to move to the position in front of the needles, and then to move to the right for completion of overlapping of the designated knitting needle; subsequently, the guide bar guides the yarn guide needles to move to the direction of the backs of the needles, and to stay at the right end of the knitting needle that has completed the lapping looping movement for completion of the lapping looping movement of the knitting needles in the course C; and
S5. the weaving processes of loops in the courses D, E, F, G, H, I, J, K, L are similar to those in S3 and S4, and the stitch lengths across the backs of the needles are 3, 3, 4, 4, 2, 2, 3, 3, and 4, respectively.

In one implementation of the present disclosure, during the formation of the loops in the course D, the yarn guide needles move transversely from the backs of the knitting needles that have completed the lapping looping movement in the course C to the left by three stitch lengths for arriving at a right end of the knitting needle needing to complete the lapping looping movement in the course D; in the process of weaving from the course B to the course C, the stitch lengths across the backs of the needles are two, the stitch lengths are less than three; in the process of weaving the course D, the tension on the yarns increases compared with that when weaving the course C, so that the tension become uneven; at this time, the tension values measured by the tension sensors at the lower ends of the yarn winding wheels are positive, then the sensors release yarn release command to the central processing chips inside the yarn winding wheels, and the central processing chips process the command and output signals to the yarn winding wheels; the yarn winding wheels rotate counterclockwise to release the yarns; at the same time, the tension sensors detect the real-time tension; when the measured tension value is 0, the sensors release yarn release stop command to the central processing chips, and the central processing chips process the command and output signals to the yarn winding wheels; and the yarn winding wheels then stop rotating counterclockwise, and the tension on the yarns becomes even.

In one implementation of the present disclosure, in the process of weaving from the course F to the course G, the backs of the knitting needles that have completed the lapping looping movement in the course F move transversely to the right by four stitch lengths for arriving at a left end of the knitting needle needing to complete the lapping looping movement in the course G; in the process of weaving from the course G to the course H, the stitch lengths across the backs of the needles are two, the stitch lengths are less than four; in the process of weaving the course H, the tension on the yarns decreases compared with that when weaving the course G, so that the tension become uneven; at this time, the tension values measured by the tension sensors at the lower ends of the yarn winding wheels are negative, then the sensors release yarn winding command to the central processing chips inside the yarn winding wheels, and the central processing chips process the command and output signals to the yarn winding wheels; the yarn winding wheels rotate clockwise to release the yarns; at the same time, the tension sensors detect the real-time tension; when the measured tension value is 0, the sensors release yarn winding stop command to the central processing chips, and the central processing chips process the command and output signals to the yarn winding wheels; and the yarn winding wheels then stop rotating counterclockwise, and the tension on the yarns becomes even.

### Beneficial Effects

(1) According to the present disclosure, the tension produced in a yarn feeding process is actively adjusted by the variable-speed tension yarn winding wheels to make up tension error caused by looping; and the present disclosure is capable of compensating in time, does not easily break the yarns, and can improve the machine operating efficiency.

(2) The tension difference in the yarn feeding process of the present disclosure is reduced, and the sizes of all loops in the fabric structure are uniform, so that the quality of a fabric surface is improved.

(3) The present disclosure detects the yarn tension through the tension sensors of the yarn winding wheels, the sensors release the command to the central processing chips, and the central processing chips process the command and output signals to be fed back to the yarn winding wheels, so that the yarn winding or yarn release command is released for adjustment of the yarn tension, which makes up for tension fluctuations, and improves the fabric quality.

(4) The yarn guide holes reserved in the yarn guide plates of the present disclosure are configured to separate all the yarns so as to allow the yarns not to be not intertwined with each other, which improves the fabric quality.

### BRIEF DESCRIPTION OF FIGURES

FIG. 1 is a schematic diagram of the structure of a yarn feeding device according to the present disclosure,

FIG. 2 is a schematic diagram of the structure of a yarn winding wheel according to the present disclosure,

FIG. 3 is a top view schematic diagram of the yarn winding wheel and a connecting rod frame according to the present disclosure,

FIG. 4 is a side view schematic diagram of the yarn winding wheel and the connecting rod frame according to the present disclosure,

FIG. 5 is a front view of the connecting rod frame according to the present disclosure,

FIG. 6 is a positional arrangement diagram of a yarn guide plate and yarn guide holes reserved therein according to the present disclosure,

FIG. 7 is a working principle diagram of a tension adjustment method of the yarn feeding device according to the present disclosure, and

FIG. 8 is a diagram showing the movement trajectory of a yarn drawn by a certain yarn guide needle in the process of a weaving method according to the present disclosure.

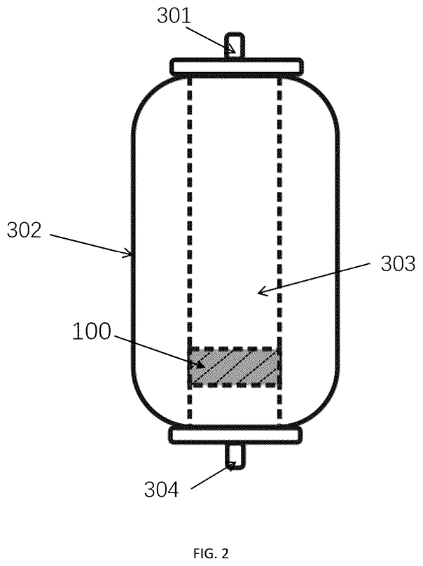

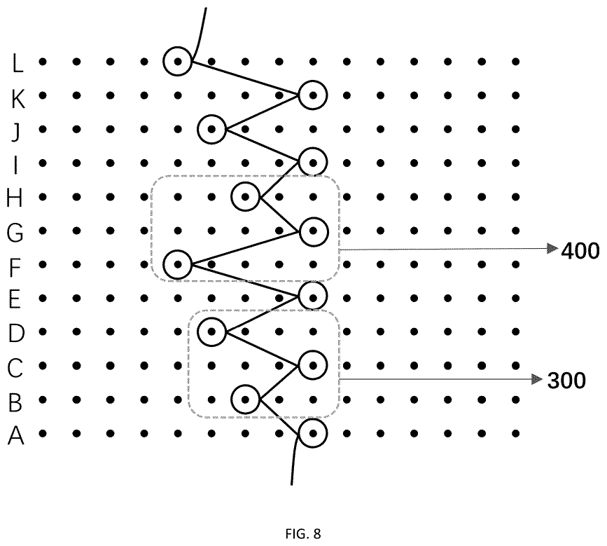

In figures: 1 denotes warp beams, 2 denotes connecting rod frames, 3 denotes yarn winding wheels, 4 denotes yarn guide plates, 41 denotes yarn guide holes, 5 denotes tension rods, 6 denotes a guide bar, 7 denotes a sinker, 8 denotes a sinker bed, 9 denotes a needle core bed, 10 denotes a needle bed, 11 denotes knitting needles, 12 denotes a cloth pressing roller, 13 denotes a drawing roller, 14 denotes yarns, 15 denotes a needle core, 301 denotes yarn inlets, 302 denotes dust covers, 303 denotes yarn winding shafts, and 304 denotes yarn outlets. The shadow 100 in FIG. 2 is an installation area for the tension sensors, the 200 in FIG. 5 represents a tension reset button, and the areas 300 and 400 in FIG. 8 are local yarn movement trajectories.

### DETAILED DESCRIPTION

In order to make the objectives, technical solutions, and advantages of the present disclosure clearer, the present disclosure will be further described in detail below in conjunction with specific embodiments and with reference to accompanying drawings. The same components and parts are denoted by the same reference numerals. It should be noted that the terms “front”, “rear”, “left”, “right”, “upper” and “lower” used in the following description refer to directions in the drawings. The terms “inner” and “outer” are used to refer to directions toward or away from the geometric center of a particular component, respectively.

### Embodiment 1

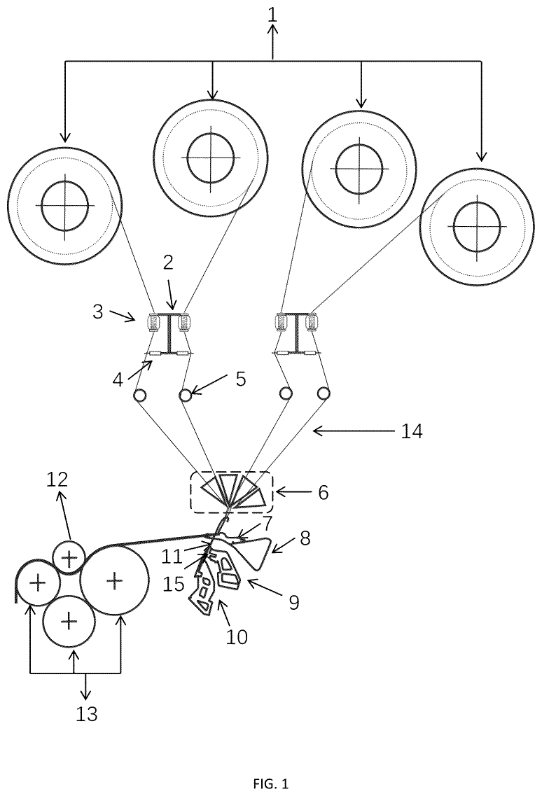

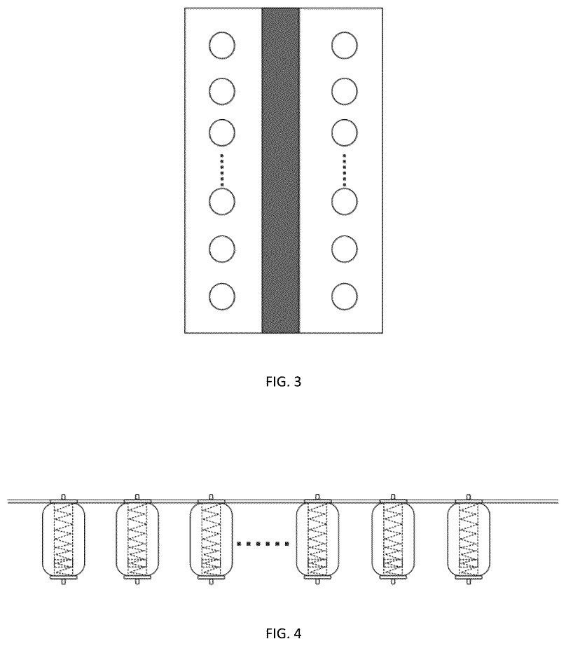

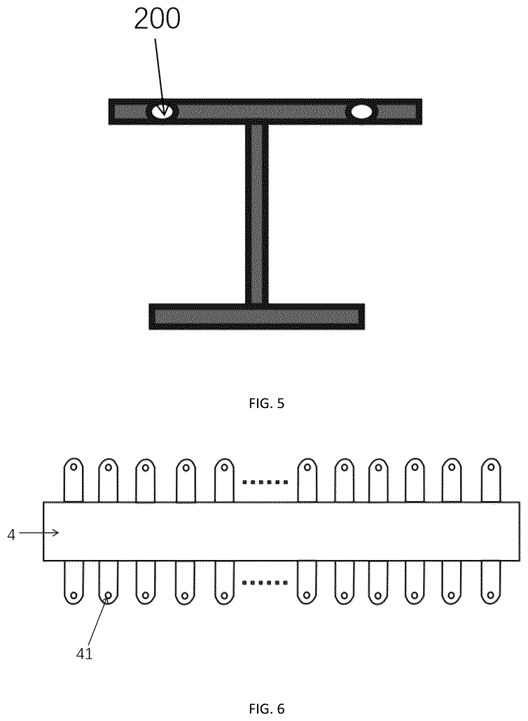

As shown in FIG. 1 to FIG. 6, this embodiment provides a warp knitting variable-speed and uniform-tension yarn feeding device, including warp beams 1, connecting rod frames 2, a guide bar 6, a looping mechanism and a drawing and rolling-up mechanism, where the connecting rod frames 2 are connected to yarn winding wheels 3 and yarn guide plates 4, the warp beams 1 are located at an area above a machine, yarns 14 are wound on the warp beams 1, and the same type of yarns 14 are wound on one warp beam 1 or a group of warp beams 1; when the machine is running, the warp beams 1 rotate in a parallel manner at a uniform speed to send out the yarns 14 and feed the yarns into the yarn winding wheels 3 connected to the connecting rod frames 2; the yarn winding wheels 3 are located between the warp beams 1 and the guide bar 6; and the yarn winding wheels 3 are configured to adjust the tension on the yarns 14 in the yarn feeding process, so that the looping process can proceed normally.

Further, the yarn winding wheels 3 are located at upper parts of the yarn guide plates 4, a plurality of yarn guide holes 41 are reserved in the yarn guide plates 4, and the yarn guide holes 41 are configured to guide the yarns 14 led out from lower ends of the yarn winding wheels 3. The two rows of yarn winding wheels 3 and yarn guide plates 4 can be placed on each of the connecting rod frames 2.

Further, every two or two groups of warp beams 1 are provided with one connecting rod frame 2, and the groups to which the warp beams 1 provided on the machine belong match the types of yarns 14. The same type of yarn is fed into the same guide bar 6.

Further, the numbers of the warp beams 1 and the connecting rod frames 2 provided on the machine are not limited to those shown in the drawings, and the numbers may be odds or evens.

Further, each of the yarn winding wheels 3 includes a yarn inlet 301, a dust cover 302, a yarn winding shaft 303, a yarn outlet 304, and a tension sensor, where the dust cover 302 is located at an outer side of the yarn winding shaft 303, the tension sensors are installed at lower ends of shaft walls of the yarn winding shafts 303, a central processing chip is also disposed in the yarn winding wheel 3, the tension sensors are configured to detect tension fluctuations in a yarn feeding process and transmit the detected data to the central processing chips, the central processing chips are also in data connection with the yarn winding shafts 303, and the central processing chips control the yarn winding shafts 303 to rotate clockwise or counterclockwise according to the detected data so as to adjust the tension on the yarns 14 in the yarn feeding process. The yarns 14 are wound on the yarn winding shafts 303 in a plurality of turns in advance after being fed into the yarn inlets 301 of the yarn winding wheels 3, and are led out from the yarn outlets 304 for passing through the yarn guide holes 41 in the yarn guide plates 4 connected to the connecting rod frames 2; and the yarn guide holes 41 are configured to separate all the yarns so as to allow the yarns not to be not intertwined with each other, which improves the fabric quality.

The yarn winding wheels 3 are variable-speed tension adjustment yarn winding wheels, the yarn winding wheels 3 can rotate; and the rotation speeds of the yarn winding wheels 3 can be changed for adjustment of the tension on the yarns 14. The yarn winding wheels 3 are a type of wheels capable of winding the yarns 14.

As shown in FIG. 1 to FIG. 5, each of the connecting rod frames 2 has an H-shaped structure, and its material is of a rigid structure. The connecting rod frames 2 are frames for fixed connection of the yarn winding wheels 3 and the yarn guide plates 4.

Optionally, the tension sensors may be micro tension sensors.

Further, yarn guide needles are distributed on the guide bar 6, and the yarns 14 led out from the warp beams 1 are fed into the looping mechanism by the yarn guide needles after adjusting the tension of the yarns 14 by the yarn winding wheels 3. The looping mechanism includes knitting needles 11, a needle bed 10, a sinker 7, a sinker bed 8, and a needle core bed 9. When the machine is not in operation, the knitting needles 11 are positioned in the needle bed 10, the sinker 7 is positioned in the sinker bed 8, and a needle core 15 is installed in the needle core bed 9; and the needle core 15 is in a matching relationship with the needle core bed 9, the needle core bed 9 is a device for installing the needle core 15, the needle bed 10 is a device for installing the knitting needles 11, and the sinker bed 8 is a slotted disc for installing the sinker 7.

The yarns 14 are allowed to make a lapping looping movement by the looping mechanism, and form greige cloth by a plurality of old loops. Specifically, during weaving, the guide bar 6 moves transversely from left to right, so that the yarn guide needles transversely move back and forth between the knitting needles 11, complete a lapping looping movement by the knitting needles; and form the greige cloth after loops disengage from the needles.

The drawing and rolling-up mechanism includes a drawing roller 13 and a cloth pressing roller 12; and the greige cloth produced by the looping mechanism is wound into the drawing roller 13 and pulled flat, and then cloth bulges are pressed by the cloth pressing roller 12, so as to keep a cloth surface even. The drawing roller 13 and the cloth pressing roller 12 are both in cylindrical structures and can rotate.

Further, tension rods 5 are provided between the yarn guide plates 4 and the guide bar 6, and the yarns 14 pass through the yarn guide holes 41 in the yarn guide plates 4 to be wound on the tension rods 5, and are then fed into the yarn guide needles at a lower end of guide bar 6. The tension rods 5 are rod structures for adjusting the tension on yarns 14.

### Embodiment 2

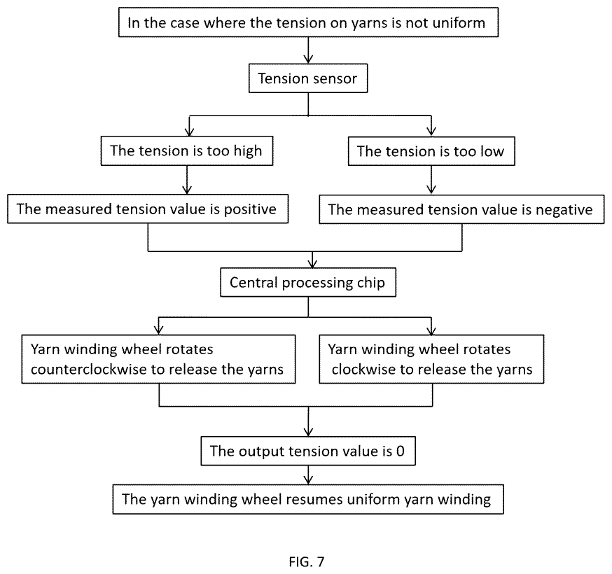

As shown in FIG. 7, this embodiment provides a tension adjustment method of a warp knitting variable-speed and uniform-tension yarn feeding device, and the method applies the warp knitting variable-speed and uniform-tension yarn feeding device provided in Embodiment 1, including the following steps:
when the tension on the yarns 14 is uniform without abnormality, the yarns 14 are wound into the yarn winding wheels 3 in a certain number of turns in advance, the warp beams 1 feed the yarns, and the yarn winding wheels 3 synchronously lead out the yarns at a constant speed; the micro tension sensors are installed within an area 100 at the lower ends of the shaft walls of the yarn winding shafts 303, as can be seen in FIG. 2; before knitting without yarn feeding, tension reset buttons 200 located at side ends of the connecting rod frames 2 are pressed, and at this time, the tension detection values of the micro tension sensors are calibrated to 0, as can be seen in FIG. 5; when the tension on the yarns becomes uneven during machine weaving, the yarns 14 wound on the yarn winding shafts 303 will cause axial compression or relaxation on the shaft walls of the yarn winding shafts 303, so that the tension values measured by the micro tension sensors positioned within the bottom end area of the yarn winding shafts 303 is increased to positive values or decreased to negative values;
when it is detected that the tension on the yarns is too high, the yarns 14 produce axial pressure on the yarn winding shafts 303, the micro tension sensors detect the tension, and the measured value is positive; subsequently, the micro tension sensors release “yarn release” command to the central processing chips inside the yarn winding wheels 3, and the central processing chips process the command and output signals to the yarn winding wheels 3; the yarn winding wheels 3 rotate counterclockwise to release the yarns 14 to make up the tension gap, and the yarns 14 wound on the yarn winding wheels 3 in advance are thus led out; at the same time, the warp beams 1 rotate synchronously to input the yarns 14 into the yarn winding wheels 3; at this time, after the micro tension sensors detect that the tension on the yarns is normal, the output tension value is 0, and the yarn winding shafts 303 resume the normal operation of uniform yarn winding;
when it is detected that the tension on the yarns is too low, the axial pressure of the yarns 14 on the yarn winding shafts 303 disappears or increases in a negative trend, the micro tension sensors detect the tension, and the measured value is negative; subsequently, the micro tension sensors release “yarn winding” command to the central processing chips inside the yarn winding wheels, and the central processing chips process the command and output signals to the yarn winding wheels; the yarn winding wheels rotate clockwise to release the yarns for relieving tension fluctuations, so that the number of winding turns of the yarns on the yarn winding shafts is increased; and at this time, after the micro tension sensors detect that the tension on the yarns is normal, the output tension value is 0, and the yarn winding shafts 303 resume the normal operation of uniform yarn winding. After the yarn tension is uniform, the machine weaves smoothly, which reduces the probability of yarn breakage, and improves the fabric quality and the production efficiency of the machine.

### Embodiment 3

This embodiment provides a warp knitting variable-speed and uniform-tension weaving method, and the method applies the warp knitting variable-speed and uniform-tension yarn feeding device provided in Embodiment 1 or the tension adjustment method of the warp knitting variable-speed and uniform-tension yarn feeding device provided in Embodiment 2.

According to the method, weaving is performed on a warp knitting machine, and the machine components involved in the weaving process mainly include the guide bar 6 and the looping mechanism. A row of horizontally mounted yarn guide needles are distributed at the lower end of the guide bar, the number of the yarn guide needles is equal to that of the knitting needles, and the guide bar 6 can be moved forward, backward, left and right. The looping mechanism includes the knitting needles 11, the needle bed 10, the sinker 7, the needle core 15, the sinker bed 8, and the needle core bed 9, and the yarn guide needles are positioned opposite to the knitting needles 11. When the machine is not in operation, the knitting needles 11 are positioned in the needle bed 10, the sinker 7 is positioned in the sinker bed 8, the needle core 15 is in a matching relationship with the needle core bed 9, and the guide bar 6 is located at the backs of the knitting needles 11.

Due to the fact that in warp knitted products, loops in a course are formed by a plurality of yarn guide needles pulling yarns at the same time, one yarn guide needle matches a single yarn, and the yarn guide needles pull the yarns to move back and forth from front to back and left to right between the knitting needles to form different motion trajectories, the loops are interlaced and connected to each other horizontally and vertically to form a fabric. Therefore, the steps of pulling the yarn with a certain yarn guide needle for knitting are mainly described in detail here. FIG. 8 is a diagram showing the local movement trajectory of a yarn drawn by a certain yarn guide needle in a product weaving process, with upper ends of the knitting needles being the direction of fronts of the needles, and lower ends thereof being the direction of backs of the needles.

The warp knitting variable-speed and uniform-tension weaving method includes the following steps:
S1. A fabric is composed of a plurality of courses and wales; the course refers to the loops arranged in the same row in a horizontal direction in FIG. 8, and the wale refers to the loops arranged in the same line in a longitudinal direction in FIG. 8. The fabric is woven from bottom to top; at the beginning of knitting the course A, the guide bar is located in the direction of backs of the needles, and thus needs to be corrected to the direction of fronts of the needles and moved to the right until moving to a right end of the selected knitting needle to complete overlapping. The knitting needle descends after being hooked into the yarns, the sinker moves radially, and the needle core 15 also descends. Accordingly; a needle mouth is blocked by the needle core 15, so that the yarns are completely locked inside the closed knitting needle, and an old loop slides upward from a needle bar along the needle core 15. The yarn guide needles swing towards the backs of the needles, and the knitting needle and the needle core 15 descend together to a lowest position. A new loop falls off from the knitting needle and becomes another old loop, and the sinker holds the newly detached old loop and pulls same in the direction opposite to the needle bed.
S2. The weaving process of loops in each of the courses is similar to that in S1, except that the movement directions of the yarn guide needles and the stitch lengths across the backs of the needles. After the loop knitting of the course A is completed, the yarn guide needles are located at the backs of the knitting needles. At this time, the guide bar guides the yarn guide needles to move transversely to the left by two stitch lengths for weaving the course B.
S3. The loops in the course B are pulled by the yarn guide needles to allow the yarns to move transversely from the backs of the knitting needles that have completed the lapping looping movement in the course A to the left by two stitch lengths for arriving at a right end of the selected knitting needle. At this time, the guide bar guides the yarn guide needles to swing to a position in front of the needles, then to move to the left for completion of overlapping of the designated knitting needle; subsequently, the guide bar guides the yarn guide needles to move to the direction of the backs of the needles for completion of the lapping looping movement of the knitting needles in the course B.
S4. The loops in the course C are pulled by the yarn guide needles to move transversely from the backs of the knitting needles that have completed the lapping looping movement in the course B to the right by two stitch lengths for arriving at a left end of the knitting needle needing to complete the lapping looping movement, and then the guide bar guides the yarn guide needles to move to the position in front of the needles, and then to move to the right for completion of overlapping of the designated knitting needle; subsequently, the guide bar guides the yarn guide needles to move to the direction of the backs of the needles, and to stay at the right end of the knitting needle that has completed the lapping looping movement for completion of the lapping looping movement of the knitting needles in the course C.
S5. The weaving processes of loops in the courses D, E, F, G, H, I, J, K, L are similar to those in S3 and S4, and the stitch lengths across the backs of the needles are 3, 3, 4, 4, 2, 2, 3, 3, and 4, respectively.

See the area 300 in FIG. 8, during the formation of the loops in the course D, the yarn guide needles move transversely from the backs of the knitting needles that have completed the lapping looping movement in the course C to the left by three stitch lengths for arriving at a right end of the knitting needle needing to complete the lapping looping movement in the course D; in the process of weaving from the course B to the course C, the stitch lengths across the backs of the needles are two, the stitch lengths are less than three; it can be seen that in the process of weaving the course D, the tension on the yarns increases compared with that when weaving the course C, so that the tension become uneven; at this time, the tension values measured by the tension sensors at the lower ends of the yarn winding wheels are positive, then the sensors release “yarn release” command to the central processing chips inside the yarn winding wheels, and the central processing chips process the command and output signals to the yarn winding wheels; the yarn winding wheels rotate counterclockwise to release the yarns; at the same time, the tension sensors detect the real-time tension; when the measured tension value is 0, the sensors release “yarn release stop” command to the central processing chips, and the central processing chips process the command and output signals to the yarn winding wheels; and the yarn winding wheels then stop rotating counterclockwise, and the tension on the yarns becomes even.

See the area 400 in FIG. 8, in the process of weaving from the course F to the course G, the backs of the knitting needles that have completed the lapping looping movement in the course F move transversely to the right by four stitch lengths for arriving at a left end of the knitting needle needing to complete the lapping looping movement in the course G; in the process of weaving from the course G to the course H, the stitch lengths across the backs of the needles are two, the stitch lengths are less than four; it can be seen that in the process of weaving the course H, the tension on the yarns decreases compared with that when weaving the course G, so that the tension become uneven; at this time, the tension values measured by the tension sensors at the lower ends of the yarn winding wheels are negative, then the sensors release “yarn winding” command to the central processing chips inside the yarn winding wheels, and the central processing chips process the command and output signals to the yarn winding wheels; the yarn winding wheels rotate clockwise to release the yarns; at the same time, the tension sensors detect the real-time tension; when the measured tension value is 0, the sensors release “yarn winding stop” command to the central processing chips, and the central processing chips process the command and output signals to the yarn winding wheels; and the yarn winding wheels then stop rotating counterclockwise, and the tension on the yarns becomes even. After the yarn tension is uniform, the machine weaves smoothly, which reduces the probability of yarn breakage, and improves the fabric quality and the production efficiency of the machine.

Although the present disclosure has been described in detail with reference to the foregoing embodiments, for those skilled in the art, it is still possible to modify the technical solutions described in the foregoing embodiments, or to perform equivalent replacements on some of the technical features. Any modification, equivalent replacement, improvement, etc. made within the spirit and principle of the present disclosure shall be included within the protection scope of the present disclosure.

What is claimed is:

1. A tension adjustment method of a yarn feeding device, wherein the yarn feeding device is applied, and
the yarn feeding device comprises warp beams (1), connecting rod frames (2), a guide bar (6), a looping mechanism and a drawing and rolling-up mechanism, wherein the connecting rod frames (2) are connected to yarn winding wheels (3) and yarn guide plates (4), yarns (14) are wound on the warp beams (1), and the yarn winding wheels (3) are positioned between the warp beams (1) and the guide bar (6); each of the yarn winding wheels (3) comprises a yarn inlet (301), a yarn winding shaft (303) and a yarn outlet (304), and a tension sensor is installed on the yarn winding shaft (303); yarn guide holes (41) are reserved in the yarn guide plates (4); the warp beams (1) rotate to send out the yarns (14), and the yarns (14) are wound on the yarn winding shafts (303) in a plurality of turns after being fed into the yarn inlets (301) of the yarn winding wheels (3), and are led out from the yarn outlets (304) for passing through the yarn guide holes (41) in the yarn guide plates (4); the yarn guide holes (41) are configured to separate all the yarns (14) so as to allow the yarns (14) not to be intertwined with each other;
each of the yarn winding wheels (3) further comprises a dust cover (302) and a central processing chip, wherein the dust cover (302) is located at an outer side of the corresponding yarn winding shaft (303); the tension sensors are installed at lower ends of shaft walls of the yarn winding shafts (303), and the yarn winding shafts (303) and the tension sensors are both in data connection with the central processing chips; the tension sensors are configured to detect tension fluctuations in a yarn feeding process and transmit the detected data to the central processing chips; the central processing chips control the yarn winding shafts (303) to rotate clockwise or counterclockwise according to the detected data so as to adjust the tension on the yarns (14) in the yarn feeding process; and
the tension adjustment method of the yarn feeding device comprises the following steps:
when the tension on the yarns (14) is uniform without abnormality, the yarns (14) are wound into the yarn winding wheels (3) in a certain number of turns in advance, the warp beams (1) feed the yarns, and the yarn winding wheels (3) synchronously lead out the yarns (14) at a constant speed; the tension sensors are installed within an area (100) at the lower ends of the shaft walls of the yarn winding shafts (303); before knitting without yarn feeding, tension reset buttons (200) located at side ends of the connecting rod frames (2) are pressed, and then the tension detection values of the tension sensors are calibrated to 0; when the tension on the yarns (14) becomes uneven during machine weaving, the yarns (14) wound on the yarn winding shafts (303) will cause axial compression or relaxation on the shaft walls of the yarn winding shafts (303), so that the tension values measured by the tension sensors positioned within the bottom end area of the yarn winding shafts (303) is increased to positive values or decreased to negative values;
when it is detected that the tension on the yarns (14) is too high, the yarns (14) produce axial pressure on the yarn winding shafts (303), the tension sensors detect the tension, and the measured value is positive; subsequently, the tension sensors release yarn release command to the central processing chips inside the yarn winding wheels (3), and the central processing chips process the command and output signals to the yarn winding wheels (3); the yarn winding wheels (3) rotate counterclockwise to release the yarns (14) to make up the tension gap, and the yarns (14) wound on the yarn winding wheels (3) in advance are thus led out; at the same time, the warp beams (1) rotate synchronously to input the yarns (14) into the yarn winding wheels (3); at this time, after the tension sensors detect that the tension on the yarns (14) is normal, the output tension value is 0, and the yarn winding shafts (303) resume the normal operation of uniform yarn winding;
when it is detected that the tension on the yarns (14) is too low, the axial pressure of the yarns (14) on the yarn winding shafts (303) disappears or increases in a negative trend, the tension sensors detect the tension, and the measured value is negative; subsequently, the tension sensors release yarn winding command to the central processing chips inside the yarn winding wheels (3), and the central processing chips process the command and output signals to the yarn winding wheels (3); the yarn winding wheels (3) rotate clockwise to release the yarns (14) for relieving tension fluctuations, so that the number of winding turns of the yarns (14) on the yarn winding shafts (303) is increased; and at this time, after the tension sensors detect that the tension on the yarns (14) is normal, the output tension value is 0, and the yarn winding shafts (303) resume the normal operation of uniform yarn winding.

2. The tension adjustment method of the yarn feeding device according to claim 1, wherein yarn guide needles are distributed on the guide bar (6), and the yarns (14) are fed into the looping mechanism by the yarn guide needles.

3. The tension adjustment method of the yarn feeding device according to claim 2, wherein the looping mechanism comprises knitting needles (11), a needle bed (10), a sinker (7), a sinker bed (8), and a needle core bed (9); the guide bar (6) transversely moves from left to right, so that the yarn guide needles transversely move back and forth between the knitting needles (11), complete a lapping looping movement by the knitting needles (11); and form greige cloth after loops disengage from the needles.

4. The tension adjustment method of the yarn feeding device according to claim 3, wherein a drawing and rolling-up mechanism comprises a drawing roller (13) and a cloth pressing roller (12); and the greige cloth produced by the looping mechanism is wound into the drawing roller (13) and pulled flat, and then cloth bulges are pressed by the cloth pressing roller (12), so as to keep a cloth surface even.

5. The tension adjustment method of the yarn feeding device according to claim 4, wherein tension rods (5) are provided between the yarn guide plates (4) and the guide bar (6), and the yarns (14) pass through the yarn guide holes (41) in the yarn guide plates (4) to be wound on the tension rods (5), and are then fed into the yarn guide needles at a lower end of guide bar (6).

6. A weaving method, wherein the tension adjustment method of the yarn feeding device according to claim 5 is applied, the weaving method comprises the following steps:
S1. a fabric is composed of a plurality of courses and wales, the fabric is woven from bottom to top; at the beginning of knitting the course A, the guide bar (6) is located in the direction of backs of the needles, and thus needs to be corrected to the direction of fronts of the needles and moved to the right until moving to a right end of the selected knitting needle (11) to complete overlapping; the knitting needle (11) descends after being hooked into the yarns (14), the sinker (7) moves radially, and a needle core (15) also descends, accordingly; a needle mouth is blocked by the needle core (15), so that the yarns (14) are completely locked inside the closed knitting needle (11), and an old loop slides upward from a needle bar along the needle core (15); the yarn guide needles swing towards the backs of the needles, and the knitting needle (11) and the needle core (15) descend together to a lowest position; a new loop falls off from the knitting needle (11) and becomes another old loop, and the sinker (7) holds the newly detached old loop and pulls same in the direction opposite to the needle bed (10);
S2. the weaving process of loops in each of the courses is similar to that in S1, except that the movement directions of the yarn guide needles and the stitch lengths across the backs of the needles; after the loop knitting of the course A is completed, the yarn guide needles are located at the backs of the knitting needles (11); at this time, the guide bar (6) guides the yarn guide needles to move transversely to the left by two stitch lengths for weaving the course B;
S3. the loops in the course B are pulled by the yarn guide needles to allow the yarns (14) to move transversely from the backs of the knitting needles (11) that have completed the lapping looping movement in the course A to the left by two stitch lengths for arriving at a right end of the selected knitting needle (11); at this time, the guide bar (6) guides the yarn guide needles to swing to a position in front of the needles, then to move to the left for completion of overlapping of the designated knitting needle (11); subsequently, the guide bar (6) guides the yarn guide needles to move to the direction of the backs of the needles for completion of the lapping looping movement of the knitting needles (11) in the course B;
S4. the loops in the course C are pulled by the yarn guide needles to move transversely from the backs of the knitting needles (11) that have completed the lapping looping movement in the course B to the right by two stitch lengths for arriving at a left end of the knitting needle (11) needing to complete the lapping looping movement, and then the guide bar (6) guides the yarn guide needles to move to the position in front of the needles, and then to move to the right for completion of overlapping of the designated knitting needle (11); subsequently, the guide bar (6) guides the yarn guide needles to move to the direction of the backs of the needles, and to stay at the right end of the knitting needle (11) that has completed the lapping looping movement for completion of the lapping looping movement of the knitting needles (11) in the course C; and
S5. the weaving processes of loops in the courses D, E, F, G, H, I, J, K, L are similar to those in S3 and S4, and the stitch lengths across the backs of the needles are 3, 3, 4, 4, 2, 2, 3, 3, and 4, respectively.

7. The weaving method according to claim 6, wherein during the formation of the loops in the course D, the yarn guide needles move transversely from the backs of the knitting needles (11) that have completed the lapping looping movement in the course C to the left by three stitch lengths for arriving at a right end of the knitting needle (11) needing to complete the lapping looping movement in the course D; in the process of weaving from the course B to the course C, the stitch lengths across the backs of the needles are two, the stitch lengths are less than three; in the process of weaving the course D, the tension on the yarns (14) increases compared with that when weaving the course C, so that the tension become uneven; at this time, the tension values measured by the tension sensors at the lower ends of the yarn winding wheels (3) are positive, then the sensors release yarn release command to the central processing chips inside the yarn winding wheels (3), and the central processing chips process the command and output signals to the yarn winding wheels (3); the yarn winding wheels (3) rotate counterclockwise to release the yarns (14); at the same time, the tension sensors detect the real-time tension; when the measured tension value is 0, the sensors release yarn release stop command to the central processing chips, and the central processing chips process the command and output signals to the yarn winding wheels (3); and the yarn winding wheels (3) then stop rotating counterclockwise, and the tension on the yarns (14) becomes even.

8. The weaving method according to claim 7, wherein in the process of weaving from the course F to the course G, the backs of the knitting needles (11) that have completed the lapping looping movement in the course F move transversely to the right by four stitch lengths for arriving at a left end of the knitting needle (11) needing to complete the lapping looping movement in the course G; in the process of weaving from the course G to the course H, the stitch lengths across the backs of the needles are two, the stitch lengths are less than four; in the process of weaving the course H, the tension on the yarns (14) decreases compared with that when weaving the course G, so that the tension become uneven; at this time, the tension values measured by the tension sensors at the lower ends of the yarn winding wheels (3) are negative, then the sensors release yarn winding command to the central processing chips inside the yarn winding wheels (3), and the central processing chips process the command and output signals to the yarn winding wheels (3); the yarn winding wheels (3) rotate clockwise to release the yarns (14); at the same time, the tension sensors detect the real-time tension; when the measured tension value is 0, the sensors release yarn winding stop command to the central processing chips, and the central processing chips process the command and output signals to the yarn winding wheels (3); and the yarn winding wheels (3) then stop rotating counterclockwise, and the tension on the yarns (14) becomes even.
